(19) United States
(12) Patent Application Publication
(10) Pub. No.: US 2023/0190429 A1
(43) Pub. Date: Jun. 22, 2023

(54) ORAL IRRIGATOR

(71) Applicant: LG HOUSEHOLD & HEALTH CARE LTD., Seoul (KR)

(72) Inventors: Chang Hwan HYUN, Seoul (KR); Seon Ung MIN, Seoul (KR); Eun Mi KIM, Seoul (KR); Ki Jung KIM, Seoul (KR)

(73) Assignee: LG HOUSEHOLD & HEALTH CARE LTD., Seoul (KR)

(21) Appl. No.: 18/078,330

(22) Filed: Dec. 9, 2022

(30) Foreign Application Priority Data
Dec. 10, 2021 (KR) 10-2021-0176884

(51) Int. Cl. A61C 17/02; A61C 17/028; A61C 1/00

(52) U.S. Cl. CPC A61C 17/0202; A61C 1/0092; A61C 17/028

(57) ABSTRACT

The present disclosure relates to an oral irrigator including: a storage unit configured to store water; a pumping unit configured to pump water of the storage unit; a nozzle unit configured to inject the water pressurized by the pumping unit into an oral cavity; and a controller configured to control of the pumping unit, wherein the controller is configured to store a pattern in which an initial stage of gradually increasing load of the pumping unit, a preliminary cleaning stage of maintaining an injection pressure at a first pressure , a full-scale cleaning stage of maintaining the injection pressure higher than the first pressure and a final cleaning stage of maintaining the injection pressure at a third pressure lower than the second pressure and the load of the pumping unit is automatically controlled based on the pattern according to a one-time input of an operation signal.

### CROSS-REFERENCE TO RELATED APPLICATION

The present application claims priority under 35 U.S.C. § 119(a) to Korean patent application number 10-2021-0176884, filed on Dec. 10, 2021, in the Korean Intellectual Property Office, the entire disclosure of which is incorporated herein by reference.

### BACKGROUND

### 1. Technical Field

The present disclosure relates to an oral irrigator.

### 2. Related Art

In general, a toothbrush is mainly used to keep the oral cavity clean. The toothbrush is provided in a form including a head having a plurality of bristles and a handle, and a user removes foreign substances from the teeth through brushing that causes friction on the surfaces of the teeth using the bristles with toothpaste.

Since brushing alone does not sufficiently clean interdental and curved areas of the tooth surface, it is recommended to use an interdental toothbrush or dental floss in addition to brushing to maintain a clean tooth condition.

However, even when an auxiliary tool such as the interdental toothbrush or dental floss is used, there is inevitably a limit to cleaning power in that the user must directly contact the interdental toothbrush or the like to the area where the foreign material is located.

In order to overcome this limitation, recently, cleaning products that remove foreign substances by injecting high-pressure water have been in the spotlight. These products store water and apply pressure to the water automatically or manually, so that high-pressure water is injected through a thin nozzle to effectively remove foreign substances in the oral cavity.

However, since these water jet cleaning products inject water with a relatively strong pressure to remove foreign substances, there is a problem in that the strongly injected water is delivered to the tongue or gums at the start of operation, causing inconvenience.

### SUMMARY

The present disclosure has been made to solve the problems of the related art as described above and embodiments provide an oral irrigator that enables convenient and comfortable oral cleaning without discomfort by automatically adjusting an injection pressure according to a pattern.

In accordance with an aspect of the present disclosure, there is provided an oral irrigator including: a storage unit configured to store water; a pumping unit configured to pump water of the storage unit; a nozzle unit configured to inject the water pressurized by the pumping unit into an oral cavity; and a controller configured to control operation of the pumping unit, wherein the controller is configured to store a pattern in which an initial stage of gradually increasing load of the pumping unit, a preliminary cleaning stage of maintaining an injection pressure of the water at a first pressure for a predetermined time, a full-scale cleaning stage of maintaining the injection pressure of the water at a second pressure higher than the first pressure for a predetermined time, and a final cleaning stage of maintaining the injection pressure of the water at a third pressure lower than the second pressure for a predetermined time are sequentially performed, and the load of the pumping unit is automatically controlled based on the pattern according to a one-time input of an operation signal.

Specifically, the oral irrigator may further include a button unit configured to receive the operation signal, wherein the controller may be configured to automatically control the load of the pumping unit according to the pattern when the button unit is operated once.

Specifically, the final cleaning stage may be configured to clean gums by maintaining the injection pressure of the water at the third pressure lower than the first pressure.

Specifically, the pattern may be configured to use 80% or more of water compared to a storage capacity of the storage unit.

Specifically, the pattern may be 30 seconds or longer.

Specifically, an end stage of gradually reducing the load of the pumping unit after the final cleaning stage may be added to the pattern.

Specifically, the oral irrigator may further include a pressure controller configured to receive an input signal for adjusting the injection pressure of the pattern stored in the controller.

Specifically, the pressure controller may be provided as a slide button and may be configured to change at least the second pressure among the first to third pressures.

Specifically, the oral irrigator may further include an illuminance sensor configured to recognize ambient illuminance, and a sterilizer configured to sterilize the water stored in the storage unit, wherein the sterilizer may be configured to start sterilization of the water stored in the storage unit when it is sensed by the illuminance sensor that an ambient light is turned on.

Specifically, the sterilizer may be configured to stop the sterilization when the button unit is operated.

According to an oral irrigator according to the present disclosure, it is possible to allow an injection intensity to gradually increase at the start of operation, thereby solving the conventional inconvenience of accidentally applying strong injection water to the gums, etc., and automatically change the intensity according to a pattern to increase convenience by enabling intuitive use while saving water usage.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a perspective view of an oral irrigator in accordance with an embodiment of the present disclosure.

FIG. 2 is a block diagram of an oral irrigator in accordance with an embodiment of the present disclosure.

FIG. 3 is an operation flowchart of an oral irrigator in accordance with an embodiment of the present disclosure.

FIG. 4 is a diagram illustrating a cleaning pattern of an oral irrigator in accordance with an embodiment of the present disclosure.

### DETAILED DESCRIPTION

The objects, specific advantages and novel features of the present disclosure will become more apparent from the following detailed description and preferred embodiments taken in conjunction with the accompanying drawings. In the present specification, in adding reference numerals to components of each drawing, it should be noted that the same components are given the same number as possible even though they are shown in different drawings. In addition, in describing the present disclosure, if it is determined that a detailed description of a related known technology may unnecessarily obscure the subject matter of the present disclosure, the detailed description thereof will be omitted.

Hereinafter, preferred embodiments of the present disclosure will be described in detail with reference to the accompanying drawings.

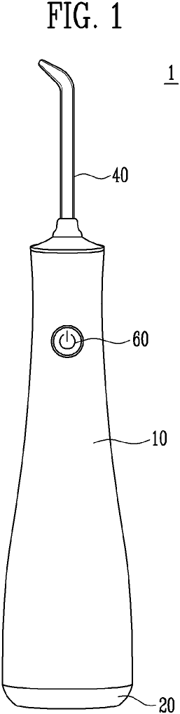

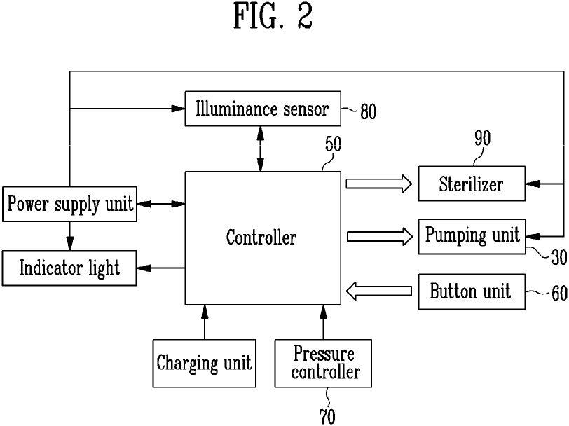

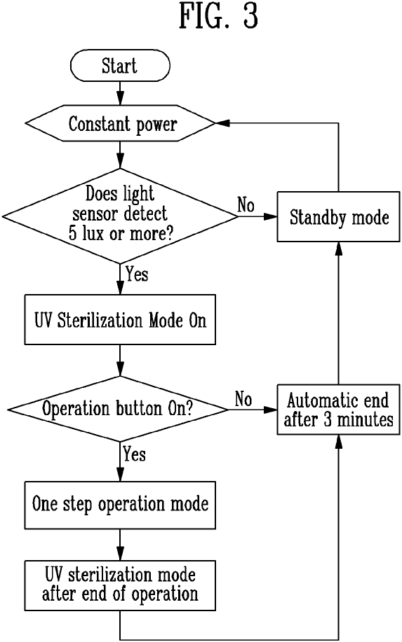

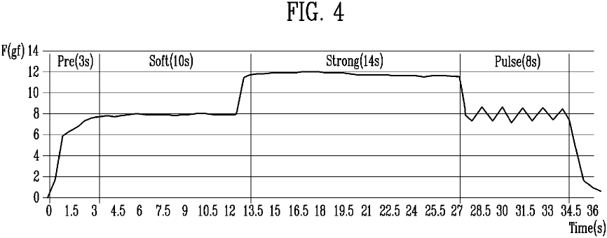

FIG. 1 is a perspective view of an oral irrigator in accordance with an embodiment of the present disclosure, FIG. 2 is a block diagram of an oral irrigator in accordance with an embodiment of the present disclosure, and FIG. 3 is an operation flowchart of an oral irrigator in accordance with an embodiment of the present disclosure. FIG. 4 is a diagram illustrating a cleaning pattern of an oral irrigator in accordance with an embodiment of the present disclosure.

Referring to FIG. 1 to FIG. 4, an oral irrigator 1 according to an embodiment of the present disclosure includes a gripper 10, a storage unit 20, a pumping unit 30, a nozzle unit 40, and a controller 50, and a button unit 60.

The gripper 10 forms a body that may be gripped by a user. The gripper 10 has a streamlined shape as shown in FIG. 1 so that the user may grip it with one hand, and the nozzle unit 40 may be detachably provided at an upper end of the gripper 10.

The gripper 10 may include the button unit 60 on the front side and the storage unit 20 on the bottom side, and when the user holds the gripper 10 and presses the button unit 60 while the nozzle unit 40 is coupled, water stored in the storage unit 20 may be injected through the nozzle unit 40. To this end, the gripper 10 may have a built-in flow path for transferring the water from the storage unit 20 to the nozzle unit 40.

Of course, the arrangement of the nozzle unit 40, the button unit 60, and the storage unit 20 with respect to the gripper 10 may be variously changed, and in this arrangement, the user may easily manipulate the button unit 60 and adjust the direction of the nozzle unit 40 while holding the gripper 10 with one hand.

The gripper 10 may include a power supply unit (symbols not shown) for implementing water injection therein, and as the power supply unit is provided in a chargeable type, the gripper 10 has a structure that facilitates charging. For example, the gripper 10 is provided in a form that may be seated on a separate cradle (not shown), and when the gripper 10 is seated on the cradle, power may be supplied from the cradle to the power supply unit in the gripper 10 through a charging unit (symbols not shown) using a connection method of electrical terminals, a wireless charging method, or the like.

The gripper 10 may be provided with an indicator light (symbols not shown) including an LED or the like on the surface, and the indicator light may be turned on or off depending on an operating state, such as whether or not water is injected. In addition, an operating state of the pumping unit 30 may be indicated by blinking the indicator light provided on the gripper 10 or changing the emission color. As will be described in detail below, load of the pumping unit 30 may be automatically adjusted according to a pattern, and the indicator light may have a different display shape depending on a stage in which the pumping unit 30 is currently operating.

The storage unit 20 stores water. At this time, the water is for cleaning an oral cavity (teeth, gums, tongue, roof of the mouth, etc.), and may be tap water that may be easily replenished in the bathroom. The storage unit 20 may be provided with an opening (not shown) so that water may be easily replenished, and the opening may be simply opened and closed by an operation of the user.

A sterilizer 90 may be provided in the storage unit 20. At least a portion of the sterilizer 90 may be provided in a direction toward the inside of the storage unit 20 to sterilize the water stored in the storage unit 20. For example, the sterilizer 90 may have a light having a wavelength having a sterilization function, and may have a shape such that a direction of emission of the light is directed toward the storage unit 20 or the emission of the light is reflected to the storage unit 20.

The sterilizer 90 sterilizes the water to be injected through the nozzle unit 40 after being stored in the storage unit 20, and at this time, the sterilization unit 90 may be operated by a separate external operation, or may be automatically operated according to On/Off of a light in the bathroom.

As an example, the present embodiment includes an illuminance sensor 80 for recognizing illuminance around the bathroom where it may be mainly located, and it may be checked whether the bathroom light is turned on by the illuminance sensor 80.

When the user turns on the light of the bathroom to enter the bathroom to use the present embodiment, as shown in FIG. 3, the illuminance sensor 80 indirectly recognizes that the present embodiment will be used soon by sensing light of 5 lux or more and sensing ON of the light. At this time, the sterilizer 90 may automatically start sterilization. In other words, the sterilizer 90 starts sterilizing the water stored in the storage unit 20 when it is sensed that an ambient light is turned on by the illuminance sensor 80.

As shown in FIG. 3, the sterilizer 90 may stop sterilization when an operation of the button unit 60 to be described later is input. In other words, the sterilizer 90 automatically ends the sterilization when the water injection by the pumping unit 30 starts.

Since the user who wants to clean the oral cavity will generally use the toothbrush first and then use the present embodiment, the sterilizer 90 may sterilize the water for about 2 minutes, which is an average brushing time.

Even if the bathroom light is turned on, the bathroom may be used for purposes other than oral cleaning. In this case, since there may be no operation of the button unit 60, the sterilizer 90 may automatically end the sterilization when an operation of the button unit 60 is input or a predetermined time (for example, about 3 minutes referring to FIG. 3) elapses.

Alternatively, the user may turn on the bathroom light and then turn off within 3 minutes. In this case, the illuminance sensor 80 does not detect whether the light is turned off, and the sterilizer 90 may implement sterilization for a certain period of time based on a timer. This is to prepare for the case where the user turns on the bathroom light, takes out the toothbrush, and then brushes teeth outside the bathroom with the bathroom light turned off, and the need to end sterilization is low even if the bathroom light is turned off.

The sterilizer 90 may start sterilization as the light in the bathroom is turned on and end the sterilization through a signal input through the button unit 60, and may further perform sterilization when the water injection is automatically ended.

However, as will be described below, when the water injection is automatically performed by the controller 50 according to a predetermined pattern, most of the water in the storage unit 20 will be consumed, so that the sterilization after the end of the water injection may be shorter or weaker than the sterilization before the start of the water injection.

In addition, in the present embodiment, in order for the storage unit 20 to be filled with water before the operation of the sterilization unit 90, the user may be advised to fill the storage unit 20 with water immediately after washing is completed or before the user enters the bathroom and brushes teeth.

The pumping unit 30 pumps water from the storage unit 20. The pumping unit 30 is accommodated in the gripper 10 and may be configured to suck water from the storage unit 20 and deliver it to the nozzle unit 40. To this end, in the pumping unit 30, a suction end may be located in the storage unit 20 and a discharge end may be located in the nozzle unit 40.

The pumping unit 30 determines an injection pressure of water injected from the nozzle unit 40 toward the oral cavity by pressurizing water and delivering it to the nozzle unit 40. In other words, the injection pressure of water may vary according to load of the pumping unit 30.

In particular, in the present embodiment, the load of the pumping unit 30 may be changed automatically without an external signal input, which will be described in detail in the process of explaining the controller 50.

The nozzle unit 40 injects water pressurized by the pumping unit 30 into the oral cavity. The nozzle unit 40 may be formed in a thin tube so that water may effectively penetrate deep into the mouth, and may also have a shape in which its upper part is bent at a certain angle in order to deliver water to the interdental space or the back of the molars.

The nozzle unit 40 has a flow path formed therein, and the water pressurized by the pumping part 30 flows at high pressure along the flow path and is injected in a straight line through the end of the nozzle unit 40. In this way, the water injected from the nozzle unit 40 may wash away foreign substances stuck in gaps in the oral cavity.

However, when the user presses the button unit 60 while holding the gripper 10, if the pumping unit 30 is directly operated with the maximum load, strong water may be injected from the nozzle unit 40. At this time, if the user makes the end of the nozzle unit 40 adjacent to the gums, there is a risk that the gums may be damaged by the high-pressure water.

In order to prepare for such a problem, the present embodiment may gradually increase the load of the pumping unit 30 during initial operation, and the pumping unit 30 operates according to a predetermined pattern in consideration of general cleaning habits of users. Therefore, in the present embodiment, even if the nozzle unit 40 is directed toward the gums at the initial stage of operation, it is possible to prevent the gums from being injured, and in general, the operating load of the pumping unit 30 is automatically adjusted by considering the habit of moving the nozzle unit 40 over time, thereby enabling efficient cleaning.

As described above, the nozzle unit 40 is provided to be detachably and may be replaced with respect to the gripper 10 or the pumping unit 30, and in a state where the nozzle unit 40 is separated from the gripper 10, the pumping unit 30 may be controlled not to operate.

The controller 50 controls the operation of the pumping unit 30. Since controlling the operation of the pumping unit 30 may be regarded as controlling injection specifications (pressure, etc.) of the water discharged from the end of the nozzle unit 40 consequently, the controller 50 controls the injection of water by the nozzle unit 40.

The controller 50 may automatically control the pumping unit 30 according to a predetermined pattern. Conventionally, when an operation is started, only a function in which water is continuously injected according to a constant fixed pressure or water is injected in the form of a pulse according to a constant variable pressure is implemented. However, the present embodiment maximizes convenience in oral cleaning by automatically controlling the pumping unit 30 by storing a predetermined pattern in consideration of the user’s habits of cleaning by using injection of water.

Hereinafter, a pattern of the pumping unit 30 used by the controller 50 will be described with reference to FIG. 4.

Referring to FIG. 4, the controller 50 may store a pattern for varying the injection pressure in stages with respect to the pumping unit 30. At this time, the pattern is configured to use 80% or more of water compared to the storage capacity of the storage unit 20, and is configured to be performed 30 seconds or more (e.g., 37 seconds to 40 seconds). In other words, one pattern may define the whole from the time when the user starts to use the oral irrigator 1 to the time at which the user ends use of it. Therefore, the user may complete the oral cleaning by injecting water according to the single pattern.

In this case, the pattern includes an initial stage, a preliminary cleaning stage, a full-scale cleaning stage, a final cleaning stage, and an end stage. The initial stage gradually increases the load of the pumping unit 30, and may occupy about 10% of the entire pattern (about 3 seconds).

If the pumping unit 30 starts to operate and immediately injects high-pressure water, the user feels uncomfortable when the nozzle unit 40 faces a soft tissue such as gums. Therefore, in order to solve this inconvenience, the present embodiment may limit the sudden increase in the pressure of water even when the water injection is started by the pumping unit 30.

For example, in the initial stage, the water injection pressure may increase rapidly enough to form a stream of water, and then gradually increase while staying at a level that allows the user to position the nozzle unit 40 in an appropriate place without causing pain to the gums. In other words, the water injection pressure in the initial stage may appear in the form of steep increase and then gradual increase.

The injection pressure in the initial stage may be regarded as a guide to direct the nozzle unit 40 to a place where cleaning is required because water has started to be injected to the user rather than for the main purpose of cleaning. In this case, since the injection pressure is low, even if water is delivered to a part that does not require cleaning, the amount of water used may be reduced, and water splashing in all directions may be prevented.

In the preliminary cleaning stage, the water injection pressure is maintained at a first pressure for a predetermined time. The preliminary cleaning stage may be referred to as, for example, a gentle cleaning stage, and the preliminary cleaning stage may be used to clean the front teeth.

The first pressure may be a pressure lower than a second pressure required to implement strong cleaning, and may be set enough to prevent excessive splashing of water without damaging the gums while smoothly implementing cleaning of the incisors and the interdental spaces of the incisors.

The preliminary cleaning stage is a stage in which cleaning is performed after the initial stage, and may start with cleaning of the front teeth that are easy to access. Since the cleaning in the preliminary cleaning stage is in the front direction of the oral cavity and the nozzle unit 40 may be moved easily to the upper and lower teeth, the preliminary cleaning stage may be shorter than the full-scale cleaning stage to be described later considering that it is easier than other cleaning operations. For example, it may be set to about 30% of the entire pattern (for example, about 10 seconds).

In the full-scale cleaning stage, the water injection pressure is maintained at the second pressure higher than the first pressure for a predetermined time. The full-scale cleaning stage is a stage of cleaning by injecting water at a high pressure such as the inside of the molars, and the second pressure may be the maximum load of the pumping unit 30.

In the present embodiment, after cleaning the incisors in the preliminary cleaning stage, cleaning such as removing plaque on the molars in the full-scale cleaning stage may be performed.

In particular, unlike the preliminary cleaning stage, which cleans the front part of the teeth, it takes time to move to both molars in the full-scale cleaning stage. Therefore, the full-scale cleaning stage may take up the most time in the entire pattern (for example, around 40-50%, around 14 seconds), and the injection pressure is set the highest, so the most water is used.

However, the full-scale cleaning stage is to implement cleaning for both molars, and it may be inconvenient if water is injected at the maximum pressure even in the process of moving the nozzle unit 40 from the left molar to the right molar, so there may be a section where the water injection pressure is lowered or stopped within 1 second in the middle of the full-scale cleaning stage. This section may be applied in the middle of the full-scale cleaning stage, and the user may be guided to change the direction of the nozzle unit 40 to the left and right through notification using a sound or the like.

In the final cleaning stage, the water injection pressure is maintained at a third pressure lower than the second pressure for a predetermined time. The final cleaning stage may be similar to the preliminary cleaning stage, except that the final cleaning stage may be for cleaning the gums while the preliminary cleaning stage is for cleaning the front teeth.

In the final cleaning stage, the third pressure may be lower than the first pressure, and the time may be similar to that of the preliminary cleaning stage. For example, the final cleaning stage may be set to about 20% of the time (e.g., about 8 seconds) with respect to the pattern.

In the final cleaning stage, a pulse may be applied. In other words, in the final cleaning stage, as shown in FIG. 4, the injection pressure may be repeatedly increased and decreased in a predetermined cycle. The increased injection pressure may be greater than the first pressure, and the decreased injection pressure may be less than the first pressure. Through such injection, the present embodiment may impart a massage effect to the gums.

In addition, in the final cleaning stage, water consumption may be saved by more than 50% compared to other cleaning stages due to the pulse effect. Although the amount of water that the storage unit 20 of the present embodiment can store is limited (about 100 ml to 300 ml, preferably 150 ml to 250 ml, and most preferably 180 ml to 220 ml), this cleaning stage uses pulse injection to obtain an effect of extending cleaning time by several seconds. In this case, the final cleaning stage may consume less water than the preliminary cleaning stage while implementing cleaning time similar to that of the preliminary cleaning stage.

In the end stage, the load of the pumping unit 30 is reduced after the final cleaning stage. The end stage is to notify the user of the automatic end of the water injection, and it is also possible to immediately turn off the load of the pumping unit 30, but the load pumping unit 30 may be gradually reduced for the last cleaning or water delivery for gargle.

This end stage may be set to about 1 second to 2 seconds, and the change in the injection pressure may be made symmetrically with the portion in which the load of the pumping unit 30 was steeply increased in the initial stage.

This pattern may be stored by the controller 50, and utilized to automatically control the pumping unit 30 according to a one-time input of an operation signal. In other words, the controller 50 automatically controls the load of the pumping unit 30 according to the pattern for 30 seconds or longer.

Therefore, in the present embodiment, in contrast to the conventional case in which the user has to use multiple buttons or press the buttons multiple times to change the injection pressure, since the load of the pumping unit 30 is automatically controlled according to the pattern according to one operation of the button unit 60, cleaning may be very convenient if the user becomes familiar with the pattern.

In other words, the present embodiment breaks away from the conventional complicated usage method of adjusting the injection pressure by manually changing the mode or changing the injection specifications by changing the nozzle unit 40. In the present embodiment, by pressing one button unit 60 once, the injection pressure from the start and the end of oral cleaning may be automatically implemented according to a predetermined pattern, thereby achieving an intuitive and simple use method.

As such, the present embodiment allows one pattern including various cleaning stages to be automatically performed by one operation, thereby maximizing convenience. Furthermore, in the present embodiment, the water storage capacity (100 ml to 300 ml, preferably 150 ml to 250 ml, and most preferably 180 ml to 220 ml) of the storage unit 20 may be determined in consideration of the size and weight that the user can hold, and, it is possible to use 80% to 95% of the water storage capacity during the entire pattern according to one operation of the button unit 60.

Through this, in the present embodiment, when the user fills up the storage unit 20 with water before cleaning and completes the cleaning of one pattern, the storage unit 20 may be almost exhausted, preventing unnecessary accumulation of water in the storage unit 20 and preventing the need to replenish water until sufficient cleaning is completed.

Further, in the present embodiment, a cleaning time of 30 seconds to 50 seconds (preferably 37 seconds to 40 seconds) may be allocated for one pattern consisting of preliminary cleaning stage, full-scale cleaning stage, final cleaning stage, and end stage. This may be the optimal time to sufficiently implement the cleaning necessary for the oral cavity and not cause discomfort to the user.

In addition, in consideration of the case where the absolute value of the injection pressure needs to be adjusted according to the user’s oral condition, the present embodiment may further include a pressure controller 70 for receiving an input signal for adjusting the injection pressure of the pattern stored in the controller 50.

The pressure controller 70 is provided as a slide button, and may increase or decrease the maximum injection pressure by changing at least the second pressure among the first to third pressures. Alternatively, the injection pressure for the entire pattern may be proportionally increased or decreased by the control of the pressure controller 70.

The button unit 60 receives an operation signal. As mentioned above while explaining the pattern to be stored in the controller 50, in the present embodiment, one button unit 60 for starting the operation of the pumping unit 30 may be provided, and when the button unit 60 is pressed, the pumping unit 30 injects water according to the predetermined pattern for 30 seconds or longer.

Therefore, in the present embodiment, there is no need to use two or more button units 60 to adjust the injection pressure, and also it is not necessary to change the mode in which the injection pressure is different from each other by pressing the button unit 60 several times, so the user’s convenience may be maximized.

In addition, since the water injection of the pumping unit 30 may be automatically terminated when the operation according to the pattern is completed, the user does not need to operate the button unit 60 to turn off the water injection. Therefore, the user may clean the oral cavity by pressing the button unit 60 for oral cleaning, and moving the nozzle unit 40 appropriately according to the pattern.

Here, the button unit 60 may be used for a function of temporarily stopping the injection, not a function of changing the injection pressure after the water injection by the pumping unit 30 starts. This is to reduce the amount of water used and prevent damage to the mucous membrane when the user wants to appropriately change the position of the nozzle unit 40.

In the present embodiment, for the sake of convenience, even when the button unit 60 has a pause function, the release of the pause may be automatically implemented. In other words, when the button unit 60 is pressed, the pumping unit 30 is temporarily stopped for 1 to 2 seconds, and then the pumping unit 30 is operated according to the pattern.

In other words, in the present embodiment, while the pattern for optimal oral cleaning is stored and the water injection is performed based on the pattern according to one operation of the button unit 60, an additional function (pause) may be provided to the button unit 60 in preparation for an unexpected case, but the operation required to press the button unit 60 may be minimized.

As such, in the present embodiment, the pattern that gradually increases the injection pressure of water may be used to solve the problem of damaging gums as water is strongly injected from the beginning, and optimal cleaning of front teeth, molars, gums, etc. may be implemented without additional manipulation of the button unit 60 by using water injection according to the pattern of 30 seconds or more.

It should be understood that the present disclosure is not limited to the embodiments described above, and combinations of the embodiments and prior arts may be included as new embodiments.

While the present disclosure has been shown and described with reference to certain exemplary embodiments thereof, it will be understood by those skilled in the art that various changes in form and details may be made therein without departing from the spirit and scope of the present disclosure as defined by the appended claims and their equivalents.

All simple changes and modifications of the present disclosure fall within the scope of the present disclosure, and the specific scope of the present disclosure will be apparent from the appended claims.

Explanation of Symbols

| | | | |
|---|---|---|---|
| 1 | Oral irrigator | 10 | Gripper |
| 20 | Storage unit | 30 | Pumping unit |
| 40 | Nozzle unit | 50 | Controller |
| 60 | Button unit | 70 | Pressure controller |
| 80 | Illuminance sensor | 90 | Sterilizer |

What is claimed is:

1. An oral irrigator comprising:
a storage unit configured to store water;
a pumping unit configured to pump water of the storage unit;
a nozzle unit configured to inject the water pressurized by the pumping unit into an oral cavity; and
a controller configured to control operation of the pumping unit,
wherein the controller is configured to store a pattern in which an initial stage of gradually increasing load of the pumping unit, a preliminary cleaning stage of maintaining an injection pressure of the water at a first pressure for a predetermined time, a full-scale cleaning stage of maintaining the injection pressure of the water at a second pressure higher than the first pressure for a predetermined time, and a final cleaning stage of maintaining the injection pressure of the water at a third pressure lower than the second pressure for a predetermined time are sequentially performed, and
the load of the pumping unit is automatically controlled based on the pattern according to a one-time input of an operation signal.

2. The oral irrigator of claim 1, further comprising:
a button unit configured to receive the operation signal,
wherein the controller is configured to automatically control the load of the pumping unit according to the pattern when the button unit is operated once.

3. The oral irrigator of claim 1, wherein the final cleaning stage is configured to clean gums by maintaining the injection pressure of the water at the third pressure lower than the first pressure.

4. The oral irrigator of claim 1, wherein the pattern is configured to use 80% or more of water compared to a storage capacity of the storage unit.

5. The oral irrigator of claim 1, wherein the pattern is configured to 30 seconds or longer.

6. The oral irrigator of claim 1, wherein an end stage of gradually reducing the load of the pumping unit after the final cleaning stage is added to the pattern.

7. The oral irrigator of claim 1, further comprising:
a pressure controller configured to receive an input signal for adjusting the injection pressure of the pattern stored in the controller.

8. The oral irrigator of claim 7, wherein the pressure controller is provided as a slide button and is configured to change at least the second pressure among the first to third pressures.

9. The oral irrigator of claim 2, further comprising:
an illuminance sensor configured to recognize ambient illuminance; and
a sterilizer configured to sterilize the water stored in the storage unit,
wherein the sterilizer is configured to start sterilization of the water stored in the storage unit when it is sensed by the illuminance sensor that an ambient light is turned on.

10. The oral irrigator of claim 9, wherein the sterilizer is configured to stop the sterilization when the button unit is operated.
